(19) United States
(12) Patent Application Publication
(10) Pub. No.: US 2002/0189410 A1
(43) Pub. Date: Dec. 19, 2002

(54) Long nosed locking pliers with attached lug member

(76) Inventor: Gary R. Schlegel, Irwin, PA (US)

Correspondence Address: JAMES RAY & ASSOCIATES, 2640 PITCAIRN ROAD, MONROEVILLE, PA, 15146, US

(21) Appl. No.: 09/881,643

(22) Filed: Jun. 14, 2001

(51) Int. Cl. B25B 7/02

(52) U.S. Cl. 81/423

(57) ABSTRACT

In combination with a locking type plier having opposing jaw members, a first jaw member having a flat first face carried by a fixed handle and a second jaw member having a flat second face carried by a moveable handle. The first face being in a confronting relationship to the second face. A locking mechanism is secured between the fixed and moveable handles. An adjusting device is disposed on the fixed handle for changing a space between the first and second faces when the fixed and moveable handles are moved toward each other to a locked position. A release mechanism is disposed on the moveable handle for unlocking the plier. The improvement comprises a projection disposed on one of the first face and the second face for retaining a structural member against a C-shaped metal stud when the fixed handle and the moveable handle are moved toward each other.

### FIELD OF THE INVENTION

The present invention relates, in general, to a tool for use in the installation of metal building structural members and, more particularly, the present invention relates to an improved long nosed locking pliers for assisting in securing a structural member to a C-shaped stud.

### BACKGROUND OF THE INVENTION

Locking pliers and, in particular long nosed locking pliers, have been used extensively in a wide variety of applications. They have become almost a necessity in many construction jobs where it important to clamp two objects together. Clamping operations with these tools permits both hands of a workman to be free so that they can be used to attach the clamped objects together. See, for example, U.S. Pat. No. 4,541,312.

However, such long nosed locking pliers cannot be used for certain applications. One such application is the operation where a structural member has to be retained against a C-shaped metal stud so that the structural member can be attached to such C-shaped metal stud. The lip on the C-shaped metal stud prevents the locking pliers from properly clamping the structural member against the stud.

### SUMMARY OF THE INVENTION

Therefore, the present invention provides, in combination with a locking type plier having a pair of opposing jaw members, a first one of the jaw members having a substantially flat first face carried by a fixed handle and a second one of the jaw members having a substantially flat second face carried by a moveable handle, the first face of the first jaw member being in a substantially confronting relationship to the second face of the second jaw member.

There is a lever locking means secured between the fixed handle and the moveable handle, an adjusting means disposed on the fixed handle for changing a space between the first face of the first jaw member and the second face of the second jaw member when the fixed handle and the moveable handle of the locking type plier are pressed toward each other to a locked position, and a release mechanism at least partially disposed on the moveable handle for unlocking the locking type plier.

The improvement comprises a projecting means disposed on one of the first face of the first jaw member and the second face of the second jaw member for retaining a structural member against a C-shaped metal stud when the fixed handle and the moveable handle of the locking type plier are pressed toward each other.

An alternate embodiment of the invention provides an apparatus for use with a locking type plier, such plier having a pair of opposing jaw members, a first one of such jaw members having a substantially flat first face carried by a fixed handle and a second one of such jaw members having a substantially flat second face carried by a moveable handle, such first face of such first jaw member being in a substantially confronting relationship to such second face of such second jaw member, for retaining a structural member to a C-shaped metal stud, the apparatus comprises a sleeve like member having a first predetermined shape engageable with one of such first and such second jaw members of such locking type plier.

There is a lug member having a second predetermined shape and a predetermined length disposed on the sleeve like member and extending outwardly therefrom toward such face of such other of such first jaw member and such second jaw member. The apparatus further includes a means engageable with the sleeve like member and the jaw member for securing the sleeve like member to such jaw member of such locking type plier.

Another embodiment of the invention provides in combination with a locking type plier having a pair of opposing jaw members, a first one of the jaw members having a substantially flat first face carried by a fixed handle and a second one of the jaw members having a substantially flat second face carried by a moveable handle. The first face of the first jaw member being in a substantially confronting relationship to the second face of the second jaw member.

There is a lever locking means secured between the fixed handle and the moveable handle and an adjusting means disposed on the fixed handle for changing a space between the first face of the first jaw member and the second face of the second jaw member when the fixed handle and the moveable handle of the locking type plier are pressed toward each other to a locked position. There is further a release mechanism at least partially disposed on the moveable handle for unlocking the locking type plier. The improvement comprises a lug member having a predetermined shape and a predetermined length disposed closely adjacent an end of one of the first face of the first jaw member and the second face of the second jaw member. The lug member extending outwardly therefrom toward the opposite face of the first jaw member and the second jaw member for retaining a structural member against a C-shaped metal stud when the fixed handle and the moveable handle of the locking type plier are pressed toward each other.

### OBJECTS OF THE INVENTION

It is, therefore, one of the primary objects of the present invention to provide an apparatus which would assist in clamping a structural member to a C-shaped metal stud so that a worker may be able to install such member without needing assistance.

It is another object of the present invention to provide a sleeve arrangement with a lug member that can be attached and removed from a locking type plier so as to permanently alter such plier.

In addition to the numerous objects and advantages of the present invention which have been described with some degree of particularity above, it should be both noted and understood that a number of other important objects and advantages of the tool for assisting in the installation of structural panels will become more readily apparent to those persons who are skilled in the relevant building art from the following more detailed description of the invention, particularly, when such detailed description is taken in conjunction with the appended claims.

### BRIEF DESCRIPTION OF THE DRAWINGS

FIG. 1 is a side elevational view of a prior art long nose locking plier.

FIG. 2 is side elevational view of such locking type plier according to one embodiment of the invention.

FIG. 3 is a side elevational view of such locking type plier according to another embodiment of the invention.

FIG. 4 is a side elevational view of such locking type plier according to another embodiment of the invention.

FIG. 5 is a side elevational view of a sleeve and lug apparatus according to another embodiment of the invention.

FIG. 6 is a side elevational view of such locking type plier according to still another embodiment of the invention.

FIG. 7 is a side elevational view of a sleeve and lug apparatus according to yet another embodiment of the invention.

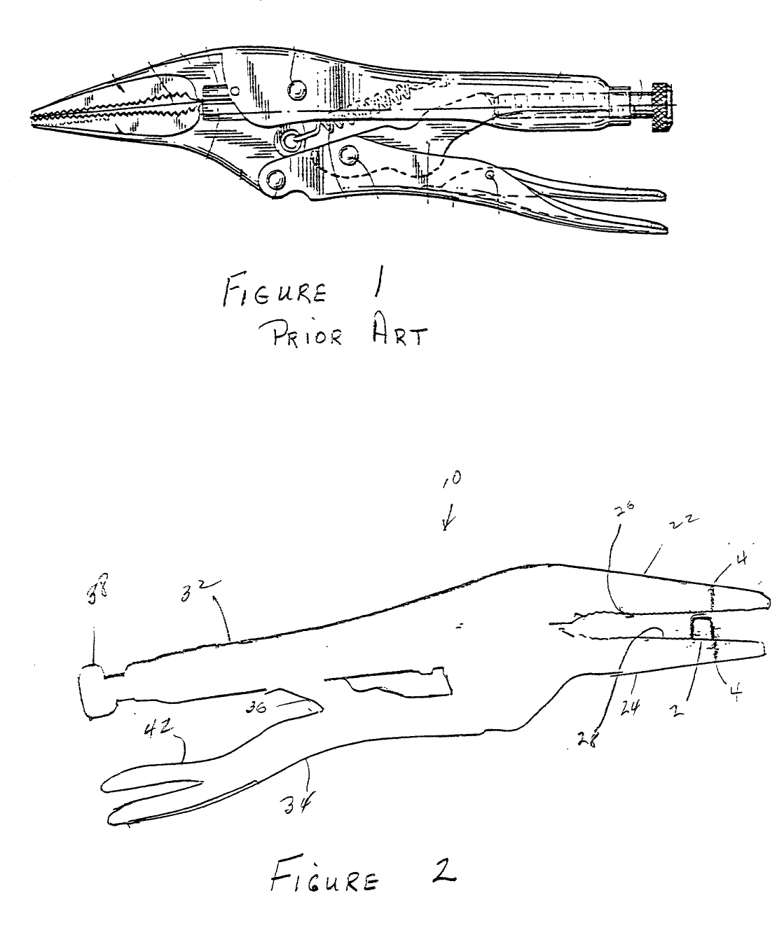

### BRIEF DESCRIPTION OF THE PRESENTLY PREFERRED AND VARIOUS ALTERNATE EMBODIMENTS OF THE PRESENT INVENTION

Prior to proceeding to the more detailed description of the present invention, it should be noted that for the sake of clarity in understanding the invention, identical components with identical functions have been designated with identical reference numerals throughout the drawing Figures.

Reference is now made to FIG. 4. Illustrated therein is an embodiment of the invention in which a locking type plier, generally designated 10, has a pair of opposing jaw members 22,24. A first one of the jaw members 22 has a substantially flat first face 26 and is carried by a fixed handle 32. A second one of the jaw members 24 also has a substantially flat second face 28 and is carried by the movable handle 34. The flat first face 26 is in a substantially confronting relationship to the flat second face 28 of the second jaw member 24.

Such locking type plier has a locking means 36 that is secured between the fixed handle 32 and the movable handle 34. There is further an adjusting means 38 that is disposed on the fixed handle 32 for changing the space between the first face 26 of the first jaw member 22 and the second face 28 of the second jaw member 24 when the fixed handle 32 and the movable handle 34 of the locking type plier 10 are pressed toward each other to a locked position. There is further a release mechanism 42 that is at least partially disposed on such movable handle 34 for unlocking such locking type plier. A more thorough description of one such prior art locking plier can be found in U.S. Pat. No. 4,541,312.

The improvement in such locking plier 10 comprises, in one embodiment of the invention, a projection, lug member 2, that is disposed on one of such first face 26 of such first jaw member 22 and such second face 28 of the second jaw member 24. Such lug member 2 can be secured to the jaw members 22,24 by means of welding or with an adhesive bond. It is presently preferred that such lug 2 be welded to such jaw member 22, 24.

Such lug 2 enables the pliers 10 to retain a structural member (not shown) against a C-shaped metal stud (not shown). The C-shaped metal stud has a curved lip which prevents such prior art locking type plier from locking securely against the flat surface of the stud. Having such projection (lug 2) on the face of either of the faces 26, 28 of the jaw members 22,24 permits the jaws 22, 24 to lock without being affected by the curved lip of the C-shaped metal stud. It may be advantageous to modify the plier 10 by removing the tips of the jaw members 22,24 at the mark 4 so as to make a stubbier version of the long nose pliers.

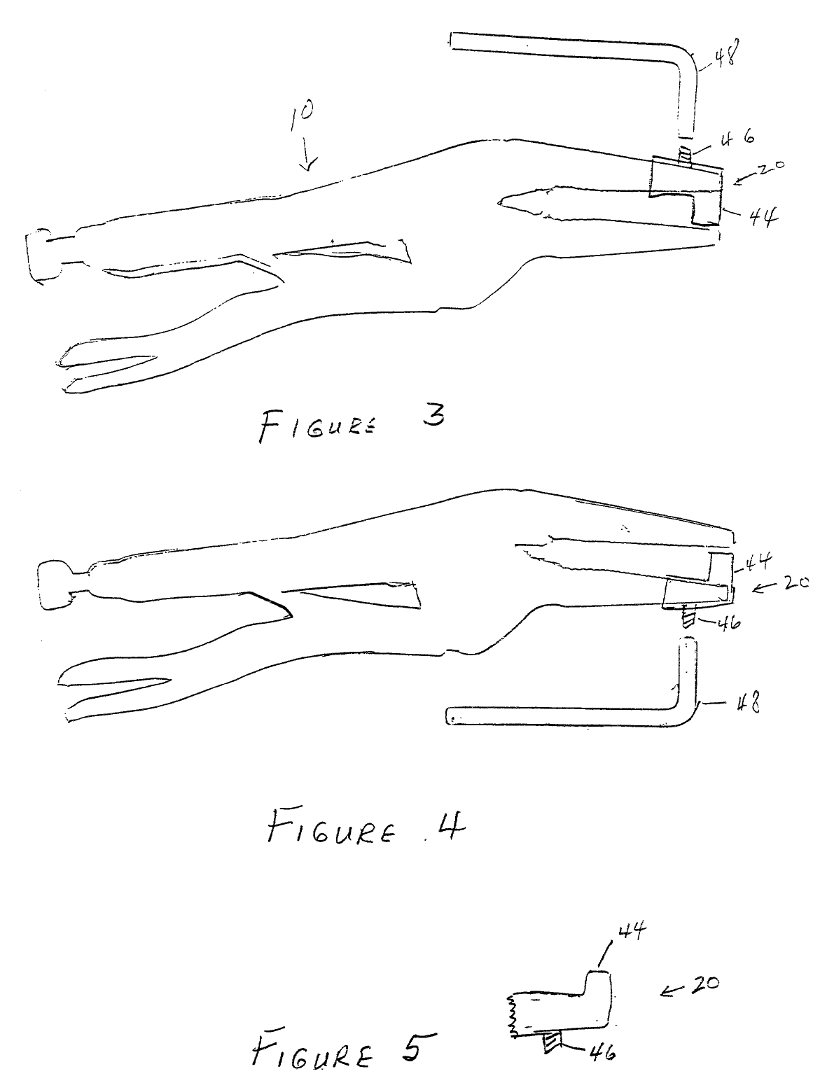

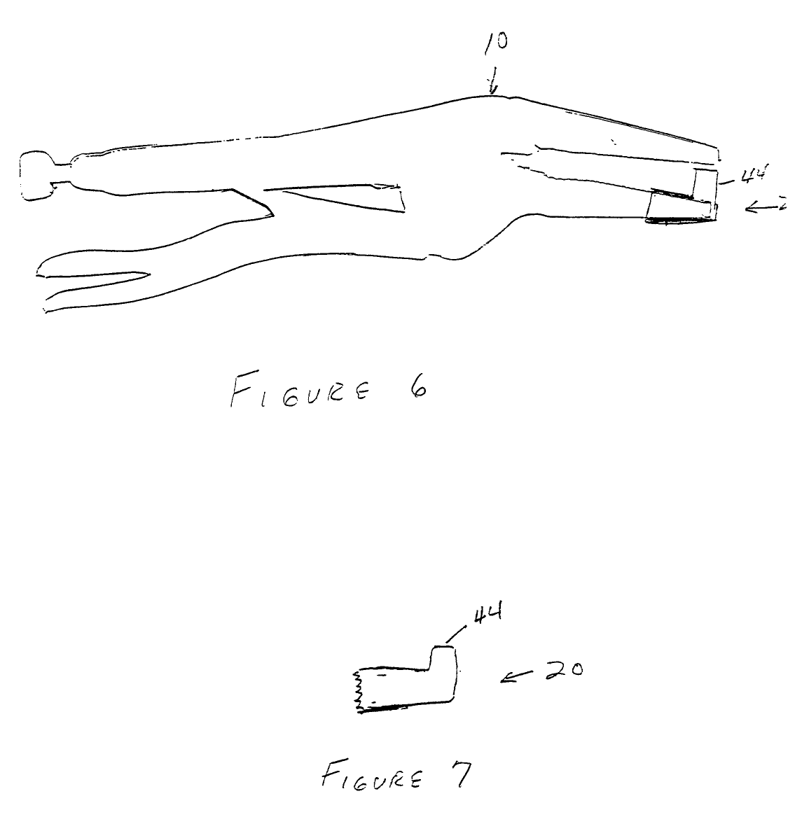

In an alternate embodiments of the invention, illustrated in FIGS. 3 through 7, a sleeve arrangement, generally designated 20, is designed to slip over the ends of one of the jaw members 22,24. Such sleeve 20 has a lug member 44 disposed closely adjacent the end of the sleeve 20 so that when the sleeve 20 is engaged to either one of the jaw members 22,24 the projecting lug member 44 extends outwardly therefrom toward the face of the opposing jaw member.

Such sleeve member 20 can be secured to one of the jaw members 22,24 of such locking type plier 10 by means of one of a press fit and a threaded connection. Such threaded connection is an allen screw 46 which can be secured to such jaw member by an alien wrench 48. In the alternate embodiment in which the sleeve 20 is press fit over one of the jaw members 22,24, the sleeve 20 has the distinct shape of the jaw members and fits snugly of the ends of the jaws. Such sleeve still has the lug member 44 to engage the opposing face of the opposing jaw member.

It is presently preferred that such sleeve member 20 be secured to such locking type plier 10 by means of such allen screw 46.

While a presently preferred embodiment and alternate embodiments of the present invention has been described in detail above, it should be understood that various other adaptations and/or modifications of the invention can be made by those persons who are particularly skilled in the building art without departing from either the spirit of the invention or the scope of the appended claims.

I claim:

1. In combination with a locking type plier having a pair of opposing jaw members, a first one of said jaw members having a substantially flat first face carried by a fixed handle and a second one of said jaw members having a substantially flat second face carried by a moveable handle, said first face of said first jaw member being in a substantially confronting relationship to said second face of said second jaw member, a locking means secured between said fixed handle and said moveable handle, an adjusting means disposed on said fixed handle for changing a space between said first face of said first jaw member and said second face of said second jaw member when said fixed handle and said moveable handle of said locking type plier are moved toward each other to a locked position, and a release mechanism at least partially disposed on said moveable handle for unlocking said locking type plier, the improvement comprising:
(a) a projecting means disposed on one of said first face of said first jaw member and said second face of said second jaw member for retaining a structural member against a C-shaped metal stud when said fixed handle and said moveable handle of said locking type plier are moved toward each other.

2. The combination, according to claim 1, wherein said projecting means includes a lug member having a first predetermined shape and a first predetermined length disposed closely adjacent an end of one of said first jaw member and said second jaw member and extending outwardly therefrom toward an opposed one of said first and said second jaw member.

3. The combination, according to claim 2, wherein said predetermined shape of said lug member is substantially that of a rectangular solid.

4. The combination, according to claim 2, wherein said lug member is one of welded and adhesively bonded to said one of said first jaw member and said second jaw member.

5. The combination, according to claim 4, wherein said lug member is welded to said one of said first jaw member and said second jaw member.

6. The combination, according to claim 1, wherein said projecting means includes a sleeve like member having a second predetermined shape for engaging one of said first jaw member and said second jaw member.

7. The combination, according to claim 6, wherein said sleeve like member further includes a lug member having a third predetermined shape and a second predetermined length disposed on said sleeve like member extending outwardly therefrom toward an opposed one of said first and said second jaw member.

8. The combination, according to claim 5, wherein said sleeve like member further includes a means for securing said sleeve like member to said one of said first jaw member and said second jaw member.

9. The combination, according to claim 8, wherein said means for securing said sleeve like member to said one of said first jaw member and said second jaw member is one of threaded and press fit.

10. The combination, according to claim 9, wherein said means for securing said sleeve like member to said one of said first jaw member and said second jaw member is threaded.

11. The combination, according to claim 10, wherein said means for securing said sleeve like member to said one of said first jaw member and said second jaw member includes an allen screw.

12. An apparatus for use with a locking type plier, such plier having a pair of opposing jaw members, a first one of such jaw members having a substantially flat first face carried by a fixed handle and a second one of said jaw members having a substantially flat second face carried by a moveable handle, such first face of such first jaw member being in a substantially confronting relationship to such second face of such second jaw member, for retaining a structural member to a C-shaped metal stud, said apparatus comprising:
(a) a sleeve like member having a first predetermined shape engageable with one of such first and such second jaw members of such locking type plier;
(b) a lug member having a second predetermined shape and a predetermined length disposed on said sleeve like member and extending outwardly therefrom toward such face of an opposed one of such first jaw member and such second jaw member; and
(c) a means engageable with said sleeve like member and said jaw member for securing said sleeve like member to such jaw member of such locking type plier.

13. An apparatus for use with a locking type plier for securing a structural member to a C-shaped metal stud, according to claim 12, wherein said second predetermined shape of said lug member is substantially a rectangular solid.

14. An apparatus for use with a locking type plier for securing a structural member to a C-shaped metal stud, according to claim 12, wherein said means for securing said sleeve like member to such jaw member is one of threaded and press fit.

15. An apparatus for use with a locking type plier for securing a structural member to a C-shaped metal stud, according to claim 14, wherein said means for securing said sleeve like member to such jaw member of such locking type plier is threaded.

16. An apparatus for use with a locking type plier for securing a structural member to a C-shaped metal stud, according to claim 15, wherein said threaded means for securing said sleeve like member to such jaw member of such locking type plier includes an allen screw.

17. In combination with a locking type plier having a pair of opposing jaw members, a first one of said jaw members having a substantially flat first face carried by a fixed handle and a second one of said jaw members having a substantially flat second face carried by a moveable handle, said first face of said first jaw member being in a substantially confronting relationship to said second face of said second jaw member, a locking means secured between said fixed handle and said moveable handle, an adjusting means disposed on said fixed handle for changing a space between said first face of said first jaw member and said second face of said second jaw member when said fixed handle and said moveable handle of said locking type plier are moved toward each other to a locked position, and a release mechanism at least partially disposed on said moveable handle for unlocking said locking type plier, the improvement comprising:
(a) a lug member having a predetermined shape and a predetermined length disposed closely adjacent an end of one of said first face of said first jaw member and said second face of said second jaw member, said lug member extending outwardly therefrom toward opposite face of said first jaw member and said second jaw member for retaining a structural member against a C-shaped metal stud when said fixed handle and said moveable handle of said locking type plier are moved toward each other.

18. The combination, according to claim 17, wherein said lug member is one of welded and adhesively bonded to said one of said first face of said first jaw member and said second face of said second jaw member.

19. The combination, according to claim 18, wherein said lug member is welded to said one of said first face of said first jaw member and said second face of said second jaw member.

20. The combination, according to claim 18, wherein said predetermined shape of said lug member is substantially a rectangular solid.
